(19) United States
(12) Patent Application Publication
(10) Pub. No.: US 2026/0334671 A1
(43) Pub. Date: Oct. 29, 2026

(54) SYSTEM FOR MANAGING THE DELIVERY OF A FOOD PRODUCT WITH DOOR CLOSURE SENSOR

(71) Applicant: Little Caesar Enterprises, Inc, Detroit, MI (US)

(72) Inventors: Kent A. Deemter, Hudsonville, MI (US); Kyle Mathew Bey, Davison, MI (US); Thomas Paul Hennessy, RoyalOak, MI (US); Andrew Boncher, Brownstown, MI (US); Garrison James Hefter, Clawson, MI (US); Edward Joseph Gleich, Detroit, MI (US); David Scrivano, Detroit, MI (US); Eric Brasseur, Detroit, MI (US); R. William Kneifel, II, Wixom, MI (US)

(73) Assignee: Little Caesar Enterprises, Inc., Detroit, MI (US)

(21) Appl. No.: 19/657,564

(22) Filed: Apr. 24, 2026

Related U.S. Application Data
(60) Provisional application No. 63/796,077, filed on Apr. 28, 2025.

(51) Int. Cl. A47B 71/00; H05B 1/02

(52) U.S. Cl. CPC A47B 71/00; H05B 1/0275

(57) ABSTRACT

A heated storage locker of a food management system includes a first side including a first locker opening, a second side including a second locker opening, a locker receptacle extending between the first locker opening and the second locker opening, and a door disposed at the first locker opening. The door extends across the first side of the locker between a first edge and a second edge. The door is configured to operate between an opened state and a closed state. The heated storage locker further includes sensor assembly disposed at the first locker opening. The sensor assembly is configured to transmit light from the first edge toward a reflector at the second edge and is further configured to detect light at the sensor assembly. The door is prevented from moving from the opened state to the closed state based on the sensor transmitting light and failing to detect light.

### CROSS-REFERENCE TO RELATED APPLICATION

This U.S. patent application claims priority under 35 U.S.C. § 119(e) to U.S. Provisional Application 63/796,077, filed on Apr. 28, 2025. The disclosure of this prior application is considered part of the disclosure of this application and is hereby incorporated by reference in its entirety.

### TECHNICAL FIELD

This disclosure relates to a system for managing the delivery of a food product, and more particularly to a system for securing an ordered food product and/or maintaining a temperature of an ordered food product prior to delivery.

### BACKGROUND

This section provides background information related to the present disclosure and is not necessarily prior art. Restaurants and other establishments that supply prepared (e.g., cooked-to-order) food products to customers often find it desirable to prepare the food product in advance of serving the food product to the customer. For example, restaurants offering carryout or take-out food service often prepare an ordered food product before the customer arrives at the restaurant to pick up the food product. In these situations, the restaurant may place the prepared food in a staging or waiting area where it can remain until it is picked up by the customer. While known systems and methods for handling and delivering prepared food products have proven acceptable for their intended use, a continuous need in the relevant art remains for improved systems and methods for ordering, handling, and delivering prepared food products.

### SUMMARY

This section provides a general summary of the disclosure and is not a comprehensive disclosure of its full scope or all of its features.

According to one aspect, the present disclosure provides a heated food storage locker. The heated food storage locker includes a cabinet including a receptacle configured to hold a food product within the receptacle, and an opening of the receptacle formed through a first side of the cabinet. The heated food storage locker further includes a door disposed at the cabinet and movable between (i) a closed position where the door extends over the opening and prevents access to the receptacle through the opening and (ii) an opened position where the door is moved away from the opening and allows access to the receptacle through the opening. The heated storage locker further includes a sensor disposed at the cabinet. The sensor includes a transmitter disposed adjacent a first side of the opening and configured to transmit a beam of light toward a reflector disposed adjacent an opposing second side of the opening, and a receiver disposed adjacent the first side of the opening and configured to detect the beam of light transmitted by the transmitter and reflected by the reflector toward the receiver.

Implementations of this aspect of the disclosure may include one or more of the following optional features. In some implementations, with the door in the opened position, and responsive to the sensor transmitting the beam of light and failing to detect the beam of light, the door is prevented from moving toward the closed position.

In some implementations, with the door in the closed position, and responsive to the sensor transmitting the beam of light and failing to detect the beam of light, the door is prevented from moving toward the opened position.

In some implementations, the door pivots at least partially upward and into the receptacle when moved from the closed position toward the opened position.

In some further implementations, the transmitter includes an upper transmitter disposed adjacent an upper portion of the first side of the opening and configured to transmit a first beam of light toward an upper reflector disposed adjacent an upper portion of the opposing second side of the opening, and a lower transmitter disposed adjacent a lower portion of the first side of the opening and configured to transmit a second beam of light toward a lower reflector disposed adjacent a lower portion of the opposing second side of the opening. The receiver includes an upper receiver disposed adjacent the upper portion of the first side of the opening and configured to detect the first beam of light transmitted by the upper transmitter and reflected by the upper reflector toward the upper receiver, and a lower receiver disposed adjacent the lower portion of the first side of the opening and configured to detect the second beam of light transmitted by the lower transmitter and reflected by the lower reflector toward the lower receiver.

In some even further implementations, with the door in the closed position, and responsive to the upper transmitter transmitting the first beam of light and the upper receiver failing to detect the first beam of light, the door is prevented from moving toward the opened position.

In some other even further implementations, with the door in the opened position, and responsive to one of (i) the upper transmitter transmitting the first beam of light and the upper receiver failing to detect the first beam of light and (ii) the lower transmitter transmitting the second beam of light and the lower receiver failing to detect the second beam of light, the door is prevented from moving toward the closed position.

In some other further implementations, with the door moving from the opened position toward the closed position, and responsive to the upper transmitter transmitting the first beam of light and the upper receiver failing to detect the first beam of light, the door is moved further toward the opened position.

In some other even further implementations, with the door moving from the opened position toward the closed position, and responsive to the lower transmitter transmitting the second beam of light and the lower receiver failing to detect the second beam of light, movement of the door toward the closed position is stopped. In some even further implementations, with movement of the door from the opened position toward the closed position stopped, and responsive to the lower transmitter transmitting the second beam of light and the lower receiver detecting the second beam of light, the door is moved further toward the closed position.

According to another aspect, the present disclosure provides a heated food storage locker. The heated food storage locker includes a cabinet including a plurality of receptacles. Each receptacle is configured to hold a food product within the respective receptacle, and a corresponding opening of each receptacle of the plurality of receptacles is formed through a first side of the cabinet. The heated food storage locker further includes a plurality of doors disposed at the cabinet. Each door of the plurality of doors corresponds to a respective receptacle of the plurality of receptacles and movable between (i) a closed position where the door extends over the corresponding opening and prevents access to the respective receptacle through the opening and (ii) an opened position where the door is moved away from the corresponding opening and allows access to the respective receptacle through the opening. The heated food storage locker further includes a plurality of sensors disposed at the cabinet. Each sensor of the plurality of sensors corresponds to a respective door of the plurality of doors and including a transmitter disposed adjacent a first side of the corresponding opening and configured to transmit a beam of light toward a reflector disposed adjacent an opposing second side of the opening, and a receiver disposed adjacent the first side of the corresponding opening and configured to detect the beam of light transmitted by the transmitter and reflected by the reflector toward the receiver.

Implementations of this aspect of the disclosure may include one or more of the following optional features. In some implementations, with one door of the plurality of doors in the opened position, and responsive to one sensor of the plurality of sensors that corresponds to the one door transmitting the beam of light and failing to detect the beam of light, the one door is prevented from moving toward the closed position.

In some implementations, with one door in the closed position, and responsive to one sensor of the plurality of sensors that corresponds to the one door transmitting the beam of light and failing to detect the beam of light, the one door is prevented from moving toward the opened position.

In some implementations, each door of the plurality of doors pivots at least partially upward and into the corresponding receptacle when moved from the closed position toward the opened position.

In some further implementations, the transmitter of each sensor of the plurality of sensors includes an upper transmitter disposed adjacent an upper portion of the first side of the corresponding opening and configured to transmit a first beam of light toward an upper reflector disposed adjacent an upper portion of the opposing second side of the opening, and a lower transmitter disposed adjacent a lower portion of the first side of the corresponding opening and configured to transmit a second beam of light toward a lower reflector disposed adjacent a lower portion of the opposing second side of the opening. The receiver of each sensor of the plurality of sensors includes an upper receiver disposed adjacent the upper portion of the first side of the corresponding opening and configured to detect the first beam of light transmitted by the upper transmitter and reflected by the upper reflector toward the upper receiver, and a lower receiver disposed adjacent the lower portion of the first side of the corresponding opening and configured to detect the second beam of light transmitted by the lower transmitter and reflected by the lower reflector toward the lower receiver.

In some even further implementations, with one door of the plurality of doors in the closed position, and responsive to the upper transmitter of one sensor of the plurality of sensors that corresponds to the one door transmitting the first beam of light and the upper receiver of the one sensor failing to detect the first beam of light, the one door is prevented from moving toward the opened position.

In some other even further implementations, with one door of the plurality of doors in the opened position, and responsive to one of (i) the upper transmitter of one sensor of the plurality of sensors that corresponds to the one door transmitting the first beam of light and the upper receiver of the one sensor failing to detect the first beam of light and (ii) the lower transmitter of one sensor of the plurality of sensors that corresponds to the one door transmitting the second beam of light and the lower receiver of the one sensor failing to detect the second beam of light, the one door is prevented from moving toward the closed position.

In some other even further implementations, with one door of the plurality of doors moving from the opened position toward the closed position, and responsive to the upper transmitter of one sensor of the plurality of sensors that corresponds to the one door transmitting the first beam of light and the upper receiver of the one sensor failing to detect the first beam of light, the one door is moved further toward the opened position.

In some other even further implementations, with one door of the plurality of doors moving from the opened position toward the closed position, and responsive to the lower transmitter of one sensor of the plurality of sensors that corresponds to the one door transmitting the second beam of light and the lower receiver of the one sensor failing to detect the second beam of light, movement of the one door toward the closed position is stopped. In some even further implementations, with movement of the one door from the opened position toward the closed position stopped, and responsive to the lower transmitter of the one sensor transmitting the second beam of light and the lower receiver of the one sensor detecting the second beam of light, the one door is moved further toward the closed position.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a front view of an example food management system in accordance with the principles of the present disclosure.

FIG. 2A is a perspective view of an example heated storage device in accordance with the principles of the present disclosure.

FIG. 2B is a front view of the heated storage device of FIG. 2A.

FIG. 2C is a rear view of the heated storage device of FIG. 2A.

FIG. 2D is a side view of the heated storage device of FIG. 2A.

FIG. 3 is a sectional view of the heated storage device of FIG. 2A.

FIG. 4 is partial perspective view of the heated storage device of FIG. 2A.

FIG. 5 is a partial front view of the heated storage device of FIG. 2A.

FIG. 6 is a flowchart of an example method of operating a food management system in accordance with the principles of the present disclosure.

FIG. 7 is a schematic diagram of an example customer door system of the food management system in accordance with the principles of the present disclosure.

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

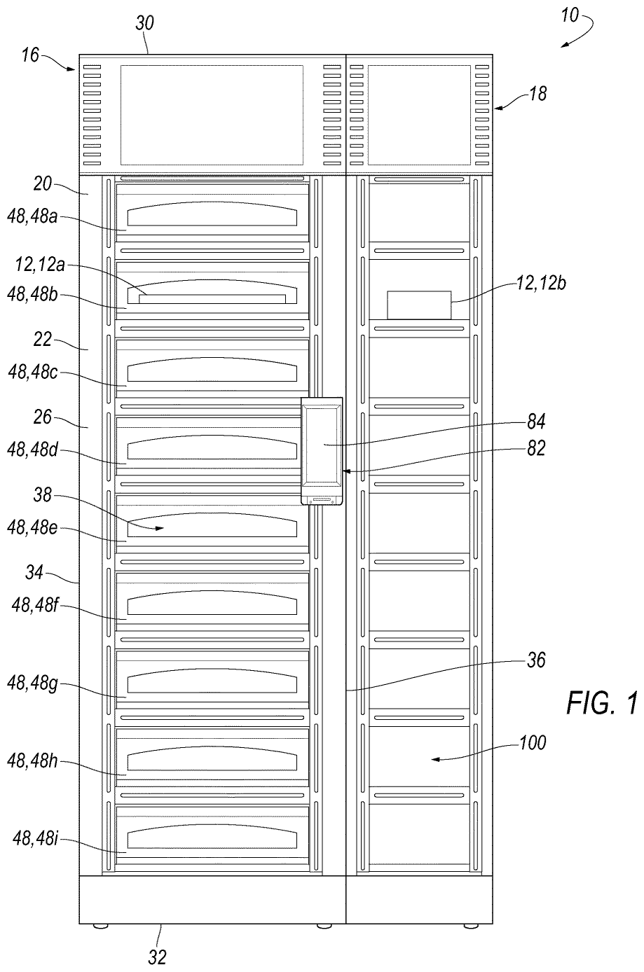

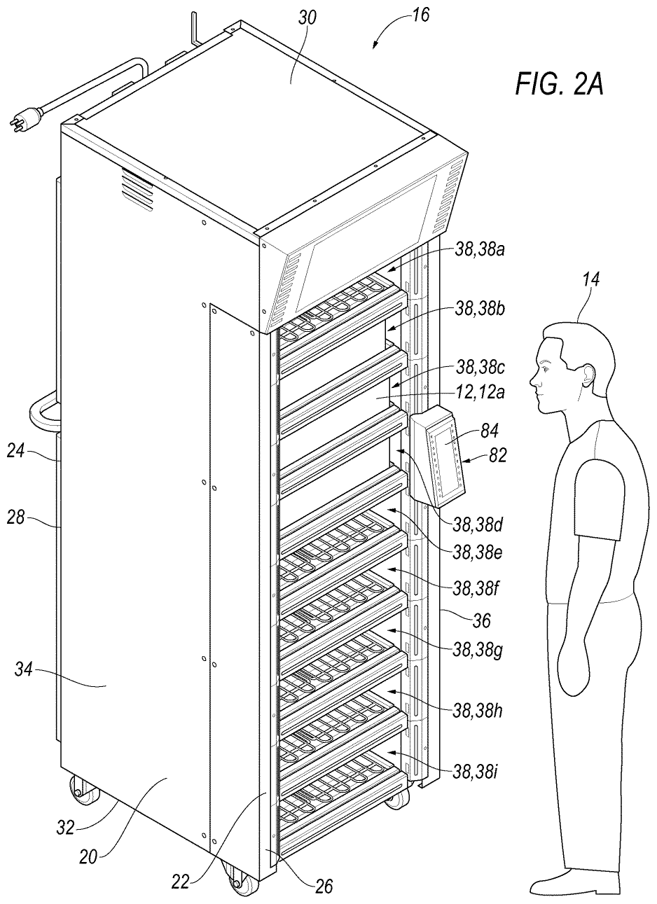

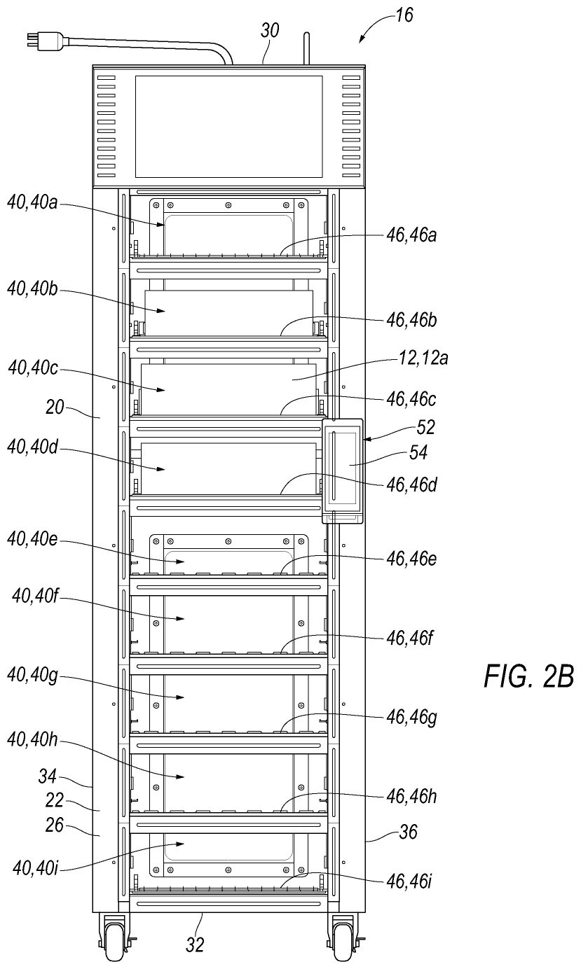

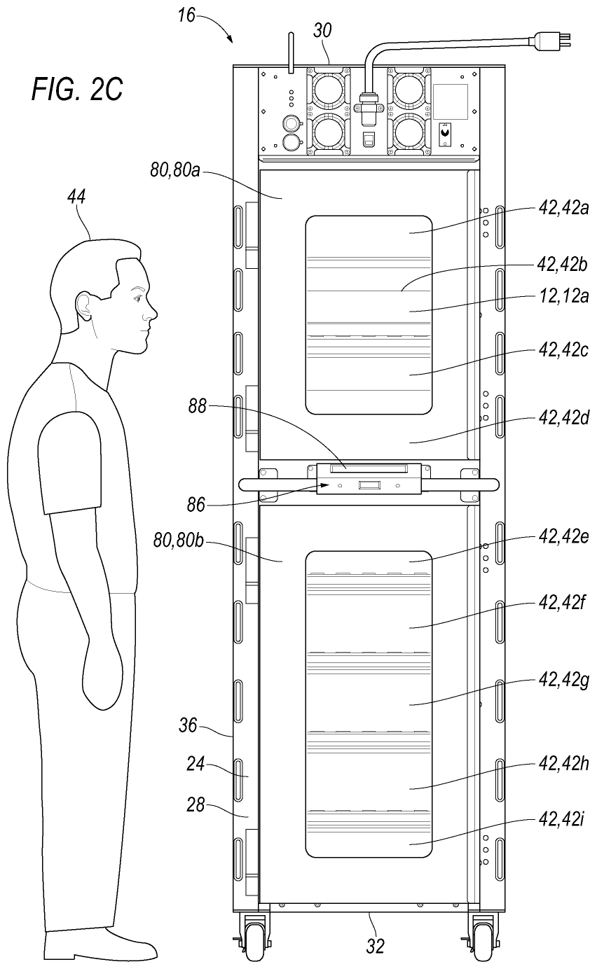

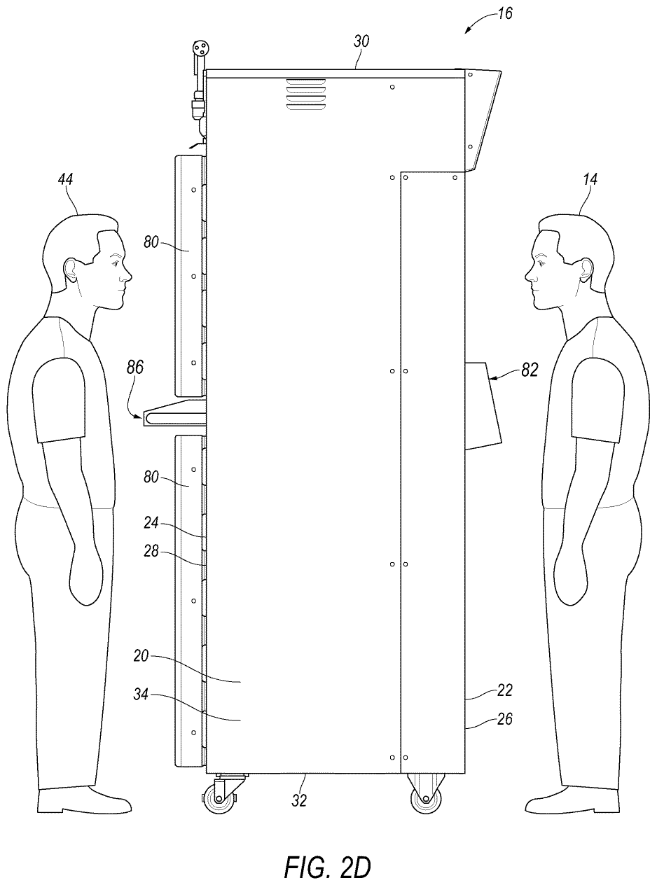

Referring to FIGS. 1 and 2A, a food management system 10 is illustrated in accordance with the principles of the present disclosure. The food management system 10 may be disposed in, and utilized by, a restaurant or other similar establishment to manage the ordering of food products 12 by, and the delivery of food products 12 to, a first user 14 such as, for example, a consumer or a third-party delivery service. For example, in some implementations, the food management system 10 may be utilized by a pizza-making restaurant. In this regard, while the food products 12 may be generally shown and described herein as including food products like pizzas, breadsticks, chicken, sauces, dessert items and beverages, for example, it will be appreciated that the food products 12 may include other items within the scope of the present disclosure. Further, the food products 12 may include at least a first food product 12a and a second food product 12b. The first food product 12a may be associated with items intended to remain hot or warm in a heated environment, such as pizzas, breadsticks, chicken, and the like. Meanwhile, the second food product 12b may be associated with items intended to remain at ambient temperature, or cold in a non-heated environment, such as sauces, dessert items, beverages, and the like. In some examples, the second food products 12b, e.g., products that do not need to be heated, may include non-food products such as shirts, hats or other merchandise, plates and other eating utensils, and the like.

The food management system 10 includes a heated storage device or storage locker 16 configured to hold first food products 12a in a heated environment for later pickup by the first user 14. Further, the food management system 10 may include a non-heated storage device or non-heated shelving unit 18 configured to hold second food products 12b in a cooled or ambient environment for later pickup by the first user 14. As discussed further below, the food management system 10 is configured to manage orders associated with the food products 12 to instruct the restaurant to make the food products 12, direct placement of the food products 12 into the heated storage locker 16 and/or the non-heated shelving unit 18, and to control and indicate pickup of the food products 12 from the heated storage locker 16 and/or the non-heated shelving unit 18 by the first user 14.

The heated storage locker 16 and the non-heated shelving unit 18 represent separate units disposed in the restaurant and may be disposed remote from one another or adjacent to one another, such as in the illustrated example. Further, the heated storage locker 16 includes one or more cabinets 20 arranged in respective columns and/or stacks. In this regard, while the heated storage locker 16 is shown and described herein as including one set or stack of cabinets 20, it should be appreciated that the heated storage locker 16 may include more than one set or stack of cabinets 20 without deviating from the context of the present disclosure.

With reference to FIGS. 2A-2D, the storage locker 16 includes a first side or front surface 22 and a second side or rear surface 24 opposite the first side 22. A front panel or wall 26 may be disposed at the first side 22 of the storage locker 16, and a rear panel or wall 28 may be disposed at the second side 24 of the storage locker 16. Further, the storage locker 16 may include an upper panel or wall 30 that extends between the first side 22 and the second side 24 at an upper portion of the storage locker 16, a lower panel or wall 32 that extends between the first side 22 and the second side 24 at a lower portion of the storage locker 16 opposite the upper portion, a first side panel or wall 34 that extends between the first side 22 and the second side 24 at a first side portion of the storage locker 16, and a second side panel or wall 36 that extends between the first side 22 and the second side 24 at a second side portion of the storage locker 16 opposite the first side portion. A plurality of chambers or locker receptacles 38 extend between the first side 22 and the second side 24 of the storage locker 16 to define the cabinets 20 and are respectively configured to hold first food products 12a. The front wall 26, rear wall 28, upper wall 30, lower wall 32, first side wall 34, and second side wall 36 may collectively surround and/or define the plurality of locker receptacles 38. While the storage locker 16 is shown and described herein as defining a substantially rectangular prism, it should be appreciated that the storage locker 16 may define other shapes surrounding the plurality of locker receptacles 38 without deviating from the context of this disclosure.

In the illustrated example, the storage locker 16 includes nine individual locker receptacles 38a-38i that are vertically disposed or stacked relative to one another between the lower wall 32 of the storage locker 16 and the upper wall 30 of the storage locker 16. A first locker receptacle 38, 38a is positioned closest to the upper wall 30 and a ninth locker receptacle 38, 38i is positioned closest to the lower wall 32. It should be appreciated that the heated storage locker 16 may include any suitable number of locker receptacles 38 without deviating from the context of this disclosure.

The first side 22 of the storage locker 16 includes a plurality of first locker openings 40 extending through the front wall 26 and in communication with the individual locker receptacles 38. In this regard, the plurality of first locker openings 40 may provide the first user 14 access to the plurality of locker receptacles 38. Further, each first locker opening 40 corresponds to a respective locker receptacle 38. The second side 24 of the storage locker 16 includes a plurality of second locker openings 42 extending through the rear wall 28 and in communication with the individual locker receptacles 38. In this regard, the plurality of second locker openings 42 may provide a second user 44 access to the plurality of locker receptacles 38. The second user 44 may be an employee or other person affiliated with the restaurant or establishment at which the food management system 10 is located. For example, the second side 24 of the storage locker 16 may face a kitchen or prep area of the venue so that the second user 44 may be granted access to the locker receptacles 38 via the second locker openings 42 while in the kitchen or prep area, while the first side 22 of the storage locker 16 faces a lobby or reception area of the venue so that the first user 14 may be granted access to the locker receptacles 38 via the first locker openings 40 while in the lobby or reception area. Further, each second locker opening 42 corresponds with a respective locker receptacle 38, such that each locker receptacle 38 extends between a corresponding first locker opening 40 and a corresponding second opening 42.

In the illustrated example, the storage locker 16 includes nine first locker openings 40a-40i, with each first locker opening 40 corresponding to a respective individual locker receptacle 38. An uppermost first locker opening 40, 40a is positioned closest to the upper wall 30 and a lowermost first locker opening 40, 40i is positioned closest to the lower wall 32. Similarly, the storage locker 16 includes nine second locker openings 42a-42i, with each second locker opening 42 corresponding to a respective individual locker receptacle 38. An uppermost second locker opening 42, 42a is positioned closest to the upper wall 30 and a lowermost second locker opening 42, 42i is positioned closest to the lower wall 32. It should be appreciated that the heated storage locker 16 may include any suitable number of first locker openings 40 and corresponding second locker openings 42 without deviating from the context of this disclosure.

Each locker receptacle 38 includes a respective receiving structure or rack or shelf 46 such that the storage locker 16 includes a plurality of racks 46. Each rack 46 may be configured to accept and hold one or more food products 12 disposed in the locker receptacle 38, and specifically, one or more first food products 12a. In this regard, the racks 46 may extend between the first side 22 and the second side 24 of the storage locker 16 and be spaced from one another between the lower wall 32 and the upper wall 30. Further, each rack 46 may be fixedly or removably attached to one or more of the front wall 26, rear wall 28, upper wall 30, lower wall 32, first side wall 34, and second side wall 36 such that each rack 46 remains rigidly disposed at a lower portion of each locker receptacle 38. Each rack 46 may be removable from the storage locker 16 via a corresponding second locker opening 42.

In the illustrated example, the storage locker 16 includes nine racks 46a-46i, with each rack 46 corresponding to a respective locker receptacle 38. A first rack 46, 46a is positioned closest to the upper wall 30 and a ninth rack 46, 46i is positioned closest to the lower wall 32. It should be appreciated that the heated storage locker 16 may include any suitable number of racks 46 without deviating from the context of this disclosure.

With continued reference to FIGS. 1-2D, the storage locker 16 may also include a plurality of first doors 48 that are movably coupled to the storage locker 16 at or near the first side 22, with each first door 48 corresponding to a respective locker receptacle 38 such that each first door 48 (i) prevents access to one of the plurality of locker receptacles 38 through the corresponding first locker opening 40 in a closed position and (ii) allows access to the one of the plurality of locker receptacles 38 through the corresponding first locker opening 40 in an opened position. In this regard, each first locker opening 40 may further include a module to detect whether the corresponding first door 48 is in the open position or the closed position. This configuration allows the first user 14 to access a desired locker receptacle 38 of the plurality of locker receptacles 38 by opening the first door 48 that corresponds to the first locker opening 40 at the desired locker receptacle 38.

The storage locker 16 may include nine first doors 48a-48i, with each first door 48 corresponding to a respective locker receptacle 38. An uppermost first door 48, 48a may be positioned closest to the upper wall 30 and a lowermost first door 48, 48i may be positioned closest to the lower wall 32. It should be appreciated that the heated storage locker 16 may include any suitable number of first doors 48 without deviating from the context of this disclosure, such as if one first door 48 covered two or more adjacent first locker openings 40 of corresponding adjacent locker receptacles 38.

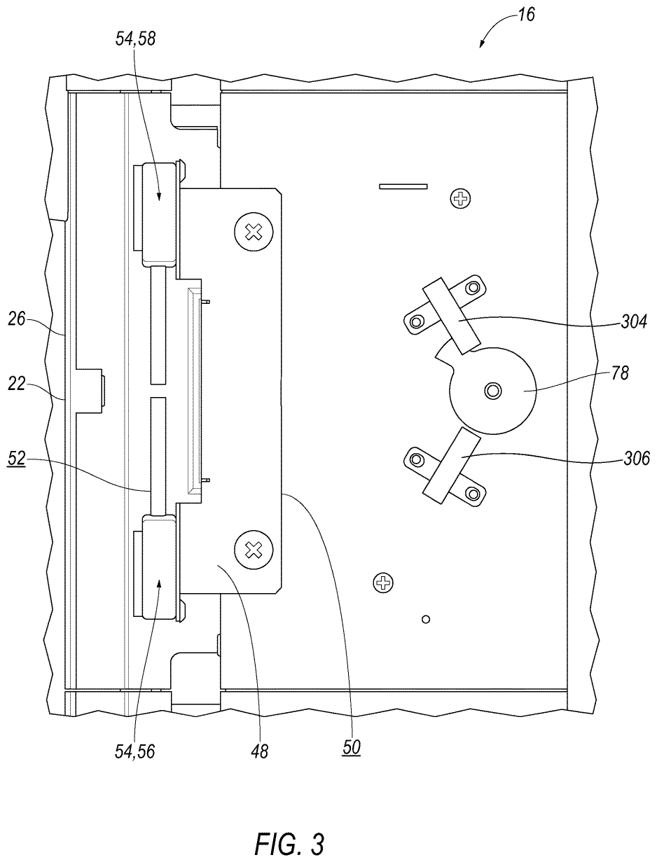

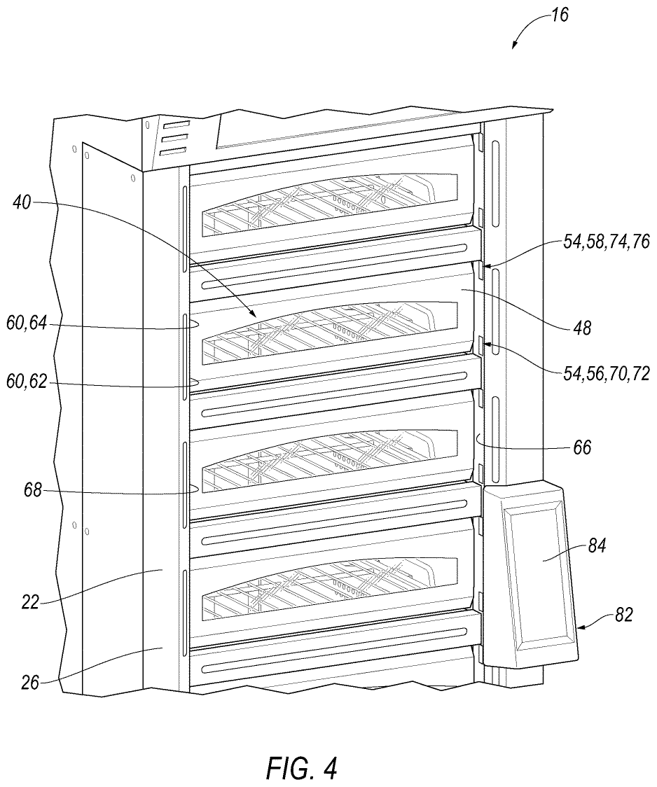

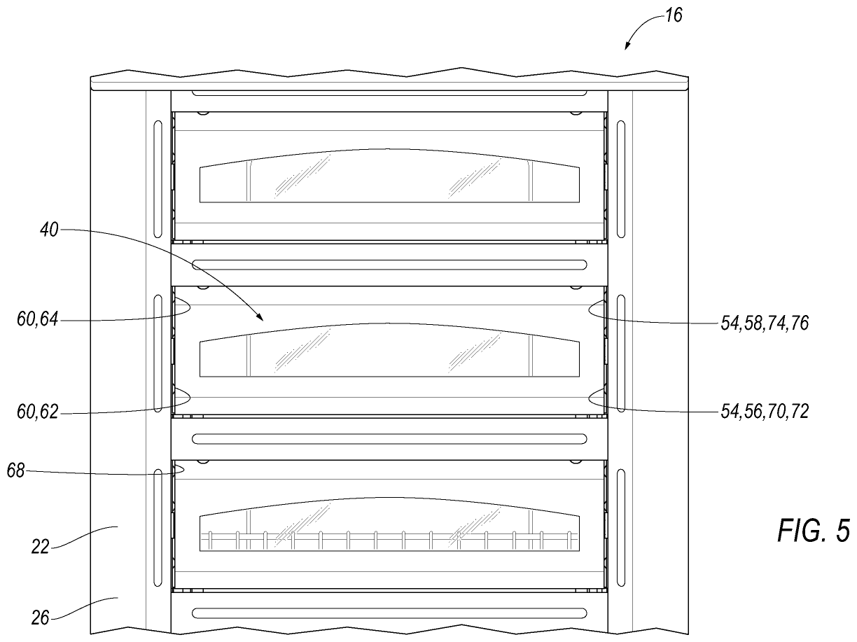

With continued reference to FIGS. 1-2D, and with reference to FIGS. 3-5, each first door 48 includes a first side 50 and a second side 52 opposite the first side 50. The first side 50 of the first door 48 faces internally or inward or toward the interior of the storage locker 16 and the second side 52 of the first door 48 faces externally or outward of the storage locker 16. Each first door 48 extends across the first side 22 of the storage locker and covers a respective first locker opening 40. When moved from the closed position toward the opened position, the door 48 may pivot or rotate in toward the locker receptacle 38 (e.g., clockwise in FIG. 3), such that the door 48 is disposed at least partially within the locker receptacle 38 and extends at or near an upper portion of the locker receptacle 38 above the food product 12. For example, the door 48 may pivot up to 90 degrees or more between the closed position and the opened position. A gasket or sealing element may extend along at least a portion of the perimeter of the door 48 to engage the storage locker 16 in the closed position and prevent heat from escaping the storage locker 16.

Further, a respective sensor assembly 54 is disposed at the storage locker 16 at or near each first locker opening 40 and operation of the door 48 may be controlled at least in part based on detection by the sensor assembly 54 of objects at or near the door 48 or first locker opening 40. For example, with the first door 48 in the opened state, the first door 48 may stay in the opened state responsive to the sensor assembly 54 detecting an object. Although the sensor assembly 54 is configured to detect any object, it may be common for the sensor assembly 54 to detect a food product 12 or a body part, such as a hand or an arm, of the first user 14, such as when the first user 14 reaches into the first locker opening 40 to obtain the food product 12 in the respective receptacle 38.

The sensor assembly 54 is disposed at a side of the storage locker 16, such as behind the first side wall 34, and is configured to sense or detect objects that cross a plane at or near the first locker opening 40 to detect objects entering and exiting the locker receptacle 38 when the door 48 is in the opened state. In the illustrated example, the sensor assembly 54 includes a first sensor 56 and a second sensor 58 that are both disposed at the side of the storage locker 16. The first sensor 56 is disposed at the side of the storage locker 16 and at or near a lower portion of the locker receptacle 38, and the second sensor 58 is disposed at the side of the storage locker 16 and at or near an upper portion of the locker receptacle 38. Accordingly, the first sensor 56 senses or detects objects that may cross the plane of the first locker opening 40 at or near the lower portion of the locker receptacle 38 and the second sensor 58 senses or detects objects that may cross the plane of the first locker opening 40 at or near the upper portion of the locker receptacle 38. This allows the sensor assembly 54 to broadly detect objects at the first locker opening 40 regardless of whether the object extends into the lower portion of the locker receptacle 38 or extends into the upper portion of the locker receptacle 38.

A reflector 60 is disposed at the side of the storage locker 16 opposite the sensor assembly 54 and includes a mirror or mirror-like object that is configured to reflect light. As discussed further below, the reflector 60 is configured to reflect light beams (e.g., beams of visible light or beams of infrared light or near infrared light) emitted by the sensor assembly 54 so that the sensors 56, 58 detect objects based on broken beams of light. In the illustrated example, the reflector 60 includes a first reflector 62 that corresponds to the first sensor 56 and a second reflector 64 that corresponds to the second sensor 58. That is, the first reflector 62 is disposed at the opposing side of the storage locker 16 at or near the lower portion of the locker receptacle 38 and the second reflector 64 is disposed at the opposing side of the storage locker 16 at or near the upper portion of the locker receptacle 38.

The first sensor 56 and the first reflector 62 are each disposed at or near opposite edges of the first locker opening 40. For example, the first sensor 56 may be disposed at a first interior panel 66 of the storage locker 16 that defines an edge of the first locker opening 40 and the first reflector 62 may be disposed at a second interior panel 68 of the storage locker 16 that defines an opposing edge of the first locker opening 40. Similarly, the second sensor 58 and the second reflector 64 are each disposed at or near opposite edges of the first locker opening 40 with the second sensor 58 disposed at the first interior panel 66 of the storage locker 16 and the second reflector 64 disposed at the second interior panel 68 of the storage locker 16. In this regard, both sensors 56, 58 may be disposed at the first interior panel 66 and both reflectors 62, 64 may be disposed at the second interior panel 68.

The first sensor 56 includes a transmitter 70 and a receiver 72. In this regard, the first sensor 56 is configured to transmit light from the transmitter 70, across the first locker opening 40, and toward the first reflector 62. The first reflector 62 is configured to reflect the light back toward the receiver 72 of the first sensor 56. Similarly, the second sensor 58 includes a transmitter 74 and a receiver 76. In this regard, the second sensor 58 is configured to transmit light from the transmitter 74, across the first locker opening 40, and toward the second reflector 64. The second reflector 64 is configured to reflect the light back toward the receiver 76 of the second sensor 58. Light emitted from the transmitters 70, 74 may include visible light, infrared light, near infrared light, and the like.

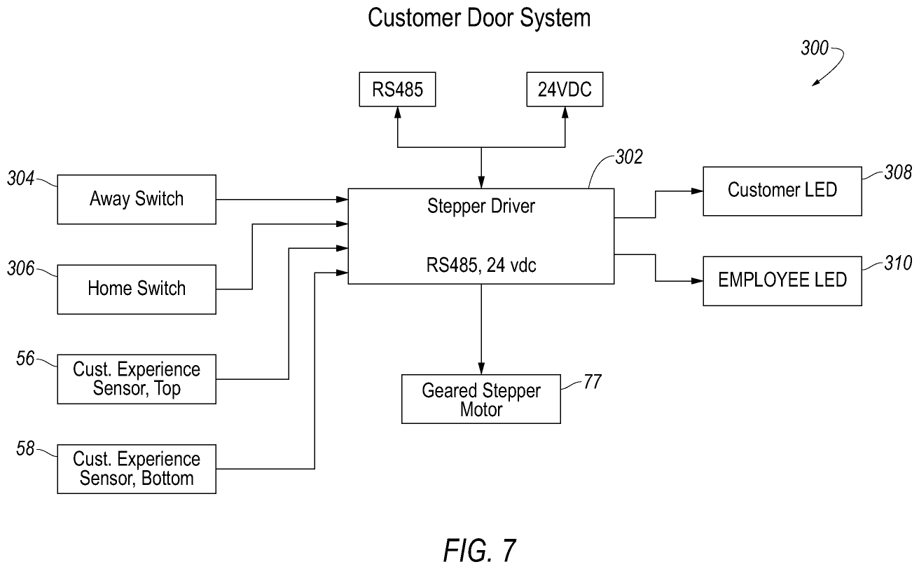

As stated above, the first door 48 is adjustable between the opened position and the closed position. Transitioning the first door 48 between the opened position and the closed position is enabled by the receiver 72 of the first sensor 56 and the receiver 76 of the second sensor 58 receiving the light reflected by the respective reflectors 62, 64. For example, a motor 77 of the first door 48 may adjust the first door 48 between the opened position and the closed position as intended during operation of the food management system 10 (FIG. 7). A door sensor flag or tab 78 may rotate according to movement of the first door 48 between the opened position and the closed position. With the door 48 in the opened position, failure by one or both of the receivers 72, 76 to receive the reflected light, may prevent the motor 77 from moving the door 48 back toward the closed position and/or the first door 48 may remain locked in the open position. The receivers 72, 76 may fail to detect light if an object, such as a hand, an arm, a food product 12, or any object, interrupts the light pathway emitted from one or both of the transmitters 70, 74 or interrupts the light pathway reflected from one or both of the reflectors 62, 64.

Thus, the sensor assembly 54 may prevent the door 48 from closing if an object is detected to prevent extremities of the first user 14 or food products 12 from being caught or pinched by the door 48. Put another way, if both of the sensors 56, 58 are unobstructed and functioning properly, a positive signal may be provided to the motor 77 and the door 48 may be moved from the opened position toward the closed position. If one or both of the sensors 56, 58 are blocked or not functioning properly, the signal may be lost or fail to be transmitted and the motor 77 may fault and stop moving the door 48. The first sensor 56 is disposed at or near the fully closed position of the door 48 and the second sensor 58 may be disposed at or near the fully opened position of the door 48.

During door opening, the second sensor 58 may inhibit movement of the door 48 from the closed position toward the opened position when the light beam is broken. When the second sensor 58 is cleared and the light beam is detected, the motor 77 may begin moving the door 48 toward the opened position again. Optionally, there is a delay, such as a five second delay, between the second sensor 58 being cleared and the motor 77 moving the door 48 further toward the opened position. During door opening, signals from the first sensor 56 may be ignored.

Further, after the door 48 is moved from the closed position to the opened position, the door 48 may remain opened before attempting to close. For example, the door 48 may remain open for 15 seconds or longer before attempting to close so that the first user 14 may retrieve their food products 12. If the first sensor 56 or the second sensor 58 are broken while the door 48 is opened, the door 48 remains opened.

During door closing, the second sensor 58 may inhibit movement of the door 48 from the opened position toward the closed position when the light beam is broken. When the second sensor 58 is cleared and the light beam is detected, the motor 77 may begin moving the door 48 toward the closed position again. Optionally, there is a delay, such as a five second delay, between the second sensor 58 being cleared and the motor 77 moving the door 48 further toward the closed position. During door closing, and responsive to the first sensor 56 being broken, the motor 77 may reverse and move the door 48 to the fully opened position. Optionally, there may be a delay, such as a delay of seven seconds, before the motor 77 begins moving the door 48 back toward the closed position.

The sensor system or assembly or module 54 may have all electronic components disposed at one side of the storage locker 16, which may reduce materials costs, maintenance needs, and installation complexity. That is, positioning the transmitters 70, 74 and the receivers 72, 76 (and optionally the motor 77) at one side of the storage locker 16 and positioning non-electronic reflectors 62, 64 at the opposing side of the storage locker 16 allows the sensor assembly 54 to sense objects across the entire first locker opening 40 without having discrete electronic components at both sides of the first locker opening 40. Moreover, this configuration may improve reliability as simpler installation of the sensor assembly 54 may lead to reduced chance of sensor misalignment or failure. This may also reduce or eliminate the need for sensor calibration as the transmitter and receiver may be disposed at the same module.

With the door 48 in the closed position, the motor 77 may be configured to resist manual movement of the door 48 toward the opened position. For example, the motor 77 may include a non-back drivable worm and worm wheel gearbox that can withstand and resist attempts of forced entry, such as up to 45 pounds of force or more.

The storage locker 16 may also include one or more second doors 80 that are movably coupled to the storage locker 16 at or near the second side 24, with each second door 80 corresponding to one or more corresponding locker receptacles 38, such that each second door 80 prevents access to one or more of the plurality of locker receptacles 38 through the corresponding one or more second locker openings 42 in a closed position and each second door 80 allows access to the one or more locker receptacles 38 through the corresponding one or more second locker openings 42 in an opened position. In the illustrated example, the storage locker 16 includes a first or upper second door 80, 80a that corresponds to at least the first locker receptacle 38a, a second locker receptacle 38b, a third locker receptacle 38c, and a fourth locker receptacle 38d. A second or lower second door 80, 80b corresponds at least to a fifth locker receptacle 38e, a sixth locker receptacle 38f, a seventh locker receptacle 38g, an eighth locker receptacle 38h, and the ninth locker receptacle 38i. Thus, the second user 44 may be granted access to more than one locker receptacle 38 at a time when opening one of the second doors 80.

A user interface 82 is disposed at the first side 22 of the storage locker 16 and does not block or interrupt or space the stack of locker receptacles 38. In other words, the user interface 82 is disposed at the first side 22 of the storage locker 16 and alongside or adjacent the locker receptacles 38. This allows the locker receptacles 38 to occupy space at the most convenient and accessible height range of the storage locker 16, while simultaneously providing access to the user interface 82 at the convenient and accessible heights. For example, the user interface 82 may be positioned adjacent to one or more of the first doors 48 at the front wall 26 of the storage locker 16. The user interface 82 includes a display screen 84 and may further include a touchscreen, a keypad, a scanner, and the like. In this regard, the first user 14 may interact with the user interface 82 in a variety of ways, such as to view messages displayed at the display screen 84 and to provide inputs at the touchscreen, the keypad, the scanner, and the like.

An employee interface 86 is disposed at the second side 24 of the storage locker 16 between respective locker receptacles 38, such as between the fourth locker receptacle 38d and the fifth locker receptacle 38e, such that the employee interface 86 is at a highly visible and accessible height for the second user 44 interacting with the employee interface 86. For example, the employee interface 86 may be disposed between the upper second door 80a and the lower second door 80b at the rear wall 28 of the storage locker 16. The employee interface 86 includes a display screen 88 that may further include a touchscreen, a keypad, a scanner, and the like. In this regard, the second user 44 may interact with the employee interface 86 in a variety of ways, such as to view messages displayed at the display screen 88 and to provide inputs at the touchscreen, the keypad, the scanner, and the like. Optionally, the display screen 88 may display a message to the second user 44 based on determination that one or more doors 48 is stuck in the opened or a partially opened position.

Thus, with the storage locker 16 disposed in the restaurant, the first user 14 may place an order for one or more food products 12, such as according to methods described further below. In response to the order, the employee interface 86 may display a message at the display screen 88 corresponding to the order of the first user 14. For example, the message at the display screen 88 may indicate the food products 12 included in the first order and where to place the food products 12 within the storage locker 16 (e.g., the message may indicate which locker receptacles 38 of the storage locker 16 should receive the first food products 12a). Responsive to the message at the display screen 88, the second user 44 may place the food products 12 in one or more respective locker receptacles 38 of the storage locker 16. When the first user 14 arrives at the restaurant, the first user 14 may provide an input, such as an identifier, to the user interface 82. The identifier may be a QR code or other scannable medium provided by the first user 14, such as via a display of a mobile device associated with the first user 14. Optionally, the identifier may include a multi-digit numerical and/or alphabetical code. As described further below, providing the identifier to the user interface 82 causes one or more corresponding first doors 48 to open and provide access to the locker receptacles 38 holding the food products 12 associated with the order of the first user 14.

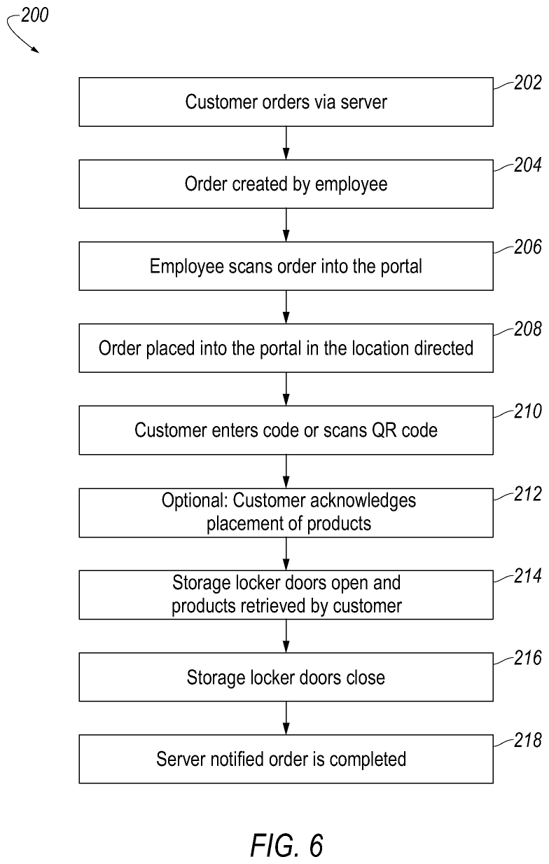

As stated above, the user interface 82 is disposed at the heated storage locker 16. However, the user interface 82 is configured to operate in conjunction with both the heated storage locker 16 and the non-heated shelving unit 18. Specifically, with reference to FIG. 6 and in a method 200 of operation of the food management system 10, at operation 202, the first user 14 places an order for the food product 12. The food product may include a first food product 12a, a second food product 12b, or both a first food product 12a and a second food product 12b. Further, the first user 14 may place the order on a mobile communication device, such as a phone, a tablet computer, or any other suitable computing device that allows the first user 14 to place an order for one or more food products 12 by communicating with the food management system 10. In this regard, the mobile communication device and the food management system 10 may communicate with and through a central processing system or server (e.g., CAESARVISION®) using wired communication and/or one or more wireless communication protocols, such as WiFi, LTE, near field communication, BLUETOOTH®, or BLE® for example.

At operation 204, the order from the first user 14 is received by the second user 44 and the second user 44 prepares the order. Preparation of the order may vary based on the food products 12 included in the order. At operation 206, the second user 44 subsequently interacts with the employee interface 86. Interacting with the employee interface 86 may include the second user 44 scanning a barcode, QR code, or any scannable medium associated with the order at a scanner of the employee interface 86. Alternatively, the second user 44 may enter a code associated with the order at a keypad or a touchscreen of the employee interface 86. For example, the scannable medium or code for inputting may be provided to the second user 44 following preparation of the food products 12. Regardless of the specific type of interaction, the employee interface 86 receives data related to the order in any suitable manner within the context of this disclosure.

After the second user 44 inputs data related to the order into the employee interface, at operation 208, the display screen 88 at the employee interface 86 provides direction regarding the specific placement of the food products 12. The second user 44 deposits the food products 12 at least one locker receptacle 38 of the plurality of locker receptacles 38 at the storage locker 16 and/or at least one shelving receptacle 100 of a plurality of shelving receptacles 100 at the non-heated shelving unit 18 based on the instruction provided at the employee interface 86. For example, the display screen 88 may direct the first food product 12a to be placed in a specific locker receptacle 38 of the heated storage locker 16. Additionally, the display screen 88 may direct the second food product 12b to be placed at a specific shelving receptacle 100 of the non-heated shelving unit 18. In another example, the display screen 88 may direct the first food product 12a to be placed in two or more specific locker receptacles 38 of the heated storage locker and direct the second food product 12b to be placed in two or more specific shelving receptacles 100 of the non-heated shelving unit 18, such as if the order includes a large quantity of food products 12. The specific locker receptacles 38 and shelving receptacles 100 directed by the display screen 88 may vary based on other food products 12 associated with other orders that may already be disposed in the heated storage locker 16 and the non-heated shelving unit 18.

At operation 210, the first user 14 provides the identifier to the user interface 82 at the heated storage locker 16. The identifier is associated with the order of the first user 14. Further, the identifier may be provided to, for example, a mobile communication device of the first user 14. Providing the identifier to the mobile communication device of the first user 14 may be accomplished via communication between the mobile communication device and the food management system 10, such as through a central processing system or server. As described above, the user interface 82 includes the display screen 84 and may further include a touchscreen, a keypad, a scanner, or something of the like. In one example, the identifier may be a QR code or other scannable medium provided by the first user 14. The first user 14 may scan the identifier at the scanner included at the user interface 82. In another example, the identifier may be a multi-digit numerical or alphabetical code. The first user 14 may enter the code at the keypad included at the user interface 82.

In some examples, the display screen 84 at the user interface 82 may display a message that indicates the specific receptacles 38, 100 that include the food products 12 associated with the order of the first user 14. At operation 212, in some optional implementations, the display screen 84 may also prompt the first user 14 to acknowledge the one or more receptacles 38, 100 that include the food products 12. For example, the user interface 82 may require the first user 14 to press the touch-screen or the keypad included at the display screen 84 to acknowledge the first food product 12a is located within a specific locker receptacle 38 in the storage locker 16 and the second food product 12b is located within a specific shelving receptacle 100 in the non-heated shelving unit 18. Further, the first user 14 may have to make a series of acknowledgements at the user interface 82 based on the quantity of receptacles 38, 100 holding the food products 12. For example, the first user 14 may have to acknowledge the placement of the first food product 12a in the one or more locker receptacles 38 in the storage locker 16 before acknowledging the placement of the second food product 12b in the one or more shelving receptacles 100 in the non-heated shelving unit 18. Optionally, the message displayed at the display screen 84 may not specify the specific receptacles 38, 100, and instead remind the first user 14 to ensure that all the food products 12 are picked up.

After the first user 14 acknowledges the placement of the food products 12, at operation 214, the first food product 12a and/or the second food product 12b are retrieved by the first user 14. In some configurations, the first user 14 may have to acknowledge the placement of the first food product 12a in the storage locker 16 and retrieve the first food product 12a before acknowledging the placement of the second food product 12b in the non-heated shelving unit 18 and subsequently retrieving the second food product 12b. Further, the first door 48 corresponding to the locker receptacle 38 holding the first food product 12a may open upon acknowledgement of the first food product 12a at the display screen. The first door 48 may be opened automatically and remain open as the first user 14 retrieves the first food product 12a, as described above. In examples wherein the non-heated shelving unit 18 includes the covering, the covering may have to be moved, pushed aside, or otherwise manipulated prior to retrieving the second food product 12b.

At operation 216, after the food products 12 have been retrieved by the first user 14, the first doors 48 associated with the order close if the beam of light is detected both of the receivers 72, 76. Finally, at operation 218, the central processing system or server is notified that the order is complete. Notification to the server may occur via wired communication and/or one or more wireless communication protocols, such as WiFi, LTE, near field communication, BLUETOOTH®, or BLE® for example.

With reference to FIG. 7, a customer door system 300 of the food management system 10 is schematically depicted. It should be appreciated that the specific configuration of the customer door system 300 may vary without deviating from the context of this disclosure.

In the illustrated example, the first sensor 56 and the second sensor 58 electrically communicate with a stepper driver 302 included at the customer door system 300. Further, an away switch or door open sensor 304 and a home switch or door closed sensor 306 may also communicate with the stepper driver 302 and the door sensor flag 78. The motor 77 may operate the first door 48 between the opened state and the closed state based on input received at the stepper driver 302 from the first sensor 56, the second sensor 58, the home switch 306, and the away switch 304. For example, the home switch 306 may indicate that the door 48 is in the closed position based on the door sensor flag 78 contacting or engaging the home switch 306 with the door in the closed position. As the door 48 moves to the opened position, the door sensor flag 78 may move into contact or engagement with the away switch 304 and the away switch 304 may signal that the door 48 is in the opened position. The stepper driver 302 may switch the operating direction of the motor 77 based on the current or last known position of the door 48. Further, the first sensor 56 and the second sensor 58 may transmit signals to the stepper driver 302 responsive to detecting an object to stop operation of the motor 77.

A customer LED light system 308 may be included at the first side 22 of the storage locker 16 to indicate which door 48 is moving from the opened state to the closed state (e.g., to signal to the first user 14 where their food products 12 are located). Similarly, an employee LED light system 310 may be included at the second side 24 of the storage locker 16 to indicate where the food products 12 should be placed. Optionally, the stepper driver 302 may transmit signals to operate the light systems 308, 310 based on the opened or closed state of the door 48 and/or the detection of an object in the opening of the door 48.

Optionally, the food management system and food locker may utilize characteristics of the food management systems and lockers described in U.S. Pub. No. US-2022-0383250, which is hereby incorporated herein by reference in its entirety.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A heated food storage locker comprising:
a cabinet including a receptacle configured to hold a food product within the receptacle, and an opening of the receptacle formed through a first side of the cabinet;
a door disposed at the cabinet and movable between (i) a closed position where the door extends over the opening and prevents access to the receptacle through the opening and (ii) an opened position where the door is moved away from the opening and allows access to the receptacle through the opening; and
a sensor disposed at the cabinet, the sensor including:
a transmitter disposed adjacent a first side of the opening and configured to transmit a beam of light toward a reflector disposed adjacent an opposing second side of the opening; and
a receiver disposed adjacent the first side of the opening and configured to detect the beam of light transmitted by the transmitter and reflected by the reflector toward the receiver.

2. The heated food storage locker of claim 1, wherein, with the door in the opened position, and responsive to the sensor transmitting the beam of light and failing to detect the beam of light, the door is prevented from moving toward the closed position.

3. The heated food storage locker of claim 1, wherein, with the door in the closed position, and responsive to the sensor transmitting the beam of light and failing to detect the beam of light, the door is prevented from moving toward the opened position.

4. The heated food storage locker of claim 1, wherein the door pivots at least partially upward and into the receptacle when moved from the closed position toward the opened position.

5. The heated food storage locker of claim 4, wherein:
the transmitter includes:
an upper transmitter disposed adjacent an upper portion of the first side of the opening and configured to transmit a first beam of light toward an upper reflector disposed adjacent an upper portion of the opposing second side of the opening; and
a lower transmitter disposed adjacent a lower portion of the first side of the opening and configured to transmit a second beam of light toward a lower reflector disposed adjacent a lower portion of the opposing second side of the opening; and
the receiver includes:
an upper receiver disposed adjacent the upper portion of the first side of the opening and configured to detect the first beam of light transmitted by the upper transmitter and reflected by the upper reflector toward the upper receiver; and
a lower receiver disposed adjacent the lower portion of the first side of the opening and configured to detect the second beam of light transmitted by the lower transmitter and reflected by the lower reflector toward the lower receiver.

6. The heated food storage locker of claim 5, wherein, with the door in the closed position, and responsive to the upper transmitter transmitting the first beam of light and the upper receiver failing to detect the first beam of light, the door is prevented from moving toward the opened position.

7. The heated food storage locker of claim 5, wherein, with the door in the opened position, and responsive to one of (i) the upper transmitter transmitting the first beam of light and the upper receiver failing to detect the first beam of light and (ii) the lower transmitter transmitting the second beam of light and the lower receiver failing to detect the second beam of light, the door is prevented from moving toward the closed position.

8. The heated food storage locker of claim 5, wherein, with the door moving from the opened position toward the closed position, and responsive to the upper transmitter transmitting the first beam of light and the upper receiver failing to detect the first beam of light, the door is moved further toward the opened position.

9. The heated food storage locker of claim 5, wherein, with the door moving from the opened position toward the closed position, and responsive to the lower transmitter transmitting the second beam of light and the lower receiver failing to detect the second beam of light, movement of the door toward the closed position is stopped.

10. The heated food storage locker of claim 9, wherein, with movement of the door from the opened position toward the closed position stopped, and responsive to the lower transmitter transmitting the second beam of light and the lower receiver detecting the second beam of light, the door is moved further toward the closed position.

11. A heated food storage locker comprising:
a cabinet including a plurality of receptacles, each receptacle configured to hold a food product within the respective receptacle, and a corresponding opening of each receptacle of the plurality of receptacles formed through a first side of the cabinet;
a plurality of doors disposed at the cabinet, each door of the plurality of doors corresponding to a respective receptacle of the plurality of receptacles and movable between (i) a closed position where the door extends over the corresponding opening and prevents access to the respective receptacle through the opening and (ii) an opened position where the door is moved away from the corresponding opening and allows access to the respective receptacle through the opening; and
a plurality of sensors disposed at the cabinet, each sensor of the plurality of sensors corresponding to a respective door of the plurality of doors and including:
a transmitter disposed adjacent a first side of the corresponding opening and configured to transmit a beam of light toward a reflector disposed adjacent an opposing second side of the opening; and
a receiver disposed adjacent the first side of the corresponding opening and configured to detect the beam of light transmitted by the transmitter and reflected by the reflector toward the receiver.

12. The heated food storage locker of claim 11, wherein, with one door of the plurality of doors in the opened position, and responsive to one sensor of the plurality of sensors that corresponds to the one door transmitting the beam of light and failing to detect the beam of light, the one door is prevented from moving toward the closed position.

13. The heated food storage locker of claim 11, wherein, with one door of the plurality of doors in the closed position, and responsive to one sensor of the plurality of sensors that corresponds to the one door transmitting the beam of light and failing to detect the beam of light, the one door is prevented from moving toward the opened position.

14. The heated food storage locker of claim 11, wherein each door of the plurality of doors pivots at least partially upward and into the corresponding receptacle when moved from the closed position toward the opened position.

15. The heated food storage locker of claim 14, wherein:
the transmitter of each sensor of the plurality of sensors includes:
an upper transmitter disposed adjacent an upper portion of the first side of the corresponding opening and configured to transmit a first beam of light toward an upper reflector disposed adjacent an upper portion of the opposing second side of the opening; and
a lower transmitter disposed adjacent a lower portion of the first side of the corresponding opening and configured to transmit a second beam of light toward a lower reflector disposed adjacent a lower portion of the opposing second side of the opening; and
the receiver of each sensor of the plurality of sensors includes:
an upper receiver disposed adjacent the upper portion of the first side of the corresponding opening and configured to detect the first beam of light transmitted by the upper transmitter and reflected by the upper reflector toward the upper receiver; and
a lower receiver disposed adjacent the lower portion of the first side of the corresponding opening and configured to detect the second beam of light transmitted by the lower transmitter and reflected by the lower reflector toward the lower receiver.

16. The heated food storage locker of claim 15, wherein, with one door of the plurality of doors in the closed position, and responsive to the upper transmitter of one sensor of the plurality of sensors that corresponds to the one door transmitting the first beam of light and the upper receiver of the one sensor failing to detect the first beam of light, the one door is prevented from moving toward the opened position.

17. The heated food storage locker of claim 15, wherein, with one door of the plurality of doors in the opened position, and responsive to one of (i) the upper transmitter of one sensor of the plurality of sensors that corresponds to the one door transmitting the first beam of light and the upper receiver of the one sensor failing to detect the first beam of light and (ii) the lower transmitter of one sensor of the plurality of sensors that corresponds to the one door transmitting the second beam of light and the lower receiver of the one sensor failing to detect the second beam of light, the door is prevented from moving toward the closed position.

18. The heated food storage locker of claim 15, wherein, with one door of the plurality of doors moving from the opened position toward the closed position, and responsive to the upper transmitter of one sensor of the plurality of sensors that corresponds to the one door transmitting the first beam of light and the upper receiver of the one sensor failing to detect the first beam of light, the one door is moved further toward the opened position.

19. The heated food storage locker of claim 15, wherein, with one door of the plurality of doors moving from the opened position toward the closed position, and responsive to the lower transmitter of one sensor of the plurality of sensors that corresponds to the one door transmitting the second beam of light and the lower receiver of the one sensor failing to detect the second beam of light, movement of the one door toward the closed position is stopped.

20. The heated food storage locker of claim 19, wherein, with movement of the one door from the opened position toward the closed position stopped, and responsive to the lower transmitter of the one sensor transmitting the second beam of light and the lower receiver of the one sensor detecting the second beam of light, the one door is moved further toward the closed position.
